(19) United States
(12) Patent Application Publication
(10) Pub. No.: US 2014/0361500 A1
(43) Pub. Date: Dec. 11, 2014

(54) EXPANDABLE ARBOR, CLAMPING SYSTEM AND METHOD OF CLAMPING ONE OF A WORKPIECE AND A TOOL TO A MACHINE

(71) Applicant: René Motschi, Delemont (CH)

(72) Inventor: René Motschi, Delemont (CH)

(73) Assignee: SCHAUBLIN SA, Delémont (CH)

(21) Appl. No.: 14/345,342

(22) PCT Filed: Sep. 19, 2011
(86) PCT No.: PCT/EP2011/066214

§ 371 Date: Jun. 24, 2014

(30) Foreign Application Priority Data
Sep. 16, 2011 (US) 61535679

(51) Int. Cl. B23B 31/40

(52) U.S. Cl. CPC B23B 31/4006; B23B 2231/20; B23B 2270/20
USPC 279/2.03; 29/559

(57) ABSTRACT

An expandable arbor for rotatably mounting an object to a machine tool comprises a mounting portion fastenable to a machine tool spindle and a clamping portion located on the mounting portion. The clamping portion comprises a finger extending from the mounting portion, an expandable sleeve coupled to the finger, and a nut for coupling the expandable sleeve to the mounting portion and for coupling the mounting portion to the rotating spindle. The expansion of the expandable sleeve allows for the clamping of the expandable sleeve to an internal surface of a tool or workpiece.

### TECHNICAL FIELD

The present invention relates generally to arbors and, more particularly, to an arbor having an expandable sleeve for engaging an inner diameter of a tool or workpiece.

### BACKGROUND

An arbor is a device on which an internal surface of an object such as a tool or workpiece can be positioned for rotation. Arbors can be cylindrical to accommodate an internal diameter of an object, or they can include flat surfaces or be irregularly-shaped to receive any suitable internal surface of an object. One typical method of clamping an object onto the arbor involves inserting the arbor through a hole in the object, inserting a bolt through a washer, and securing the bolt into the arbor such that the object is captured between the washer and the arbor. Tolerances in the arbor, the object being clamped, and the bolt are such that once secured, the object is positioned substantially concentrically relative to the arbor so as to achieve a suitable degree of rotational accuracy when the object is rotated in preparation for being worked on or for performing work.

When the tool or workpiece is mounted for rotation in a machine such as a lathe, the positioning of the tool or workpiece in the lathe affects the ability to machine the workpiece in an accurate manner. Positioning a workpiece in a rotating machine tool so that the workpiece can be machined within tight tolerances typically requires that at least a portion of the workpiece be substantially coaxial with an axis of rotation of the machine tool. Once clamped into the machine, the workpiece is adjusted to attain proper alignment and orientation. Where the workpiece or portion of the workpiece is cylindrical, the workpiece is generally adjusted to achieve concentricity within a predetermined tolerance upon rotation of the workpiece. The concentricity achieved with typical clamping using bolts and washers, as well as other methods of mechanical clamping, is often inadequate or compromised during rotation, thereby resulting in runout, which will detrimentally affect the finished workpiece.

### SUMMARY

In one aspect, the present invention resides in an expandable arbor for rotatably mounting an object to a machine tool. The expandable arbor comprises a mounting portion fastenable to a machine tool spindle and a clamping portion located on the mounting portion. The clamping portion comprises a finger extending from the mounting portion, an expandable sleeve coupled to the finger, and a nut for coupling the expandable sleeve to the mounting portion and for coupling the mounting portion to the rotating spindle. The expansion of the expandable sleeve allows for the clamping of the expandable sleeve to an internal surface of a tool or workpiece.

In another aspect, the present invention resides in a clamping system for a machine. This clamping system comprises an expandable arbor comprising a mounting portion fastenable to a rotating spindle of the machine and a clamping portion coupled to the mounting portion. The clamping portion is configured to receive one of a tool and a workpiece thereon and comprises an expandable sleeve and a nut for coupling the expandable sleeve to the mounting portion and for coupling the mounting portion to the rotating spindle. The expandable sleeve is substantially cylindrical in shape and configured to be expandable in radial directions to clamp the tool or workpiece.

In another aspect, the present invention resides in a method of clamping one of a workpiece and a tool to a machine. The method comprises the steps of providing an expandable arbor defining a mounting portion and a clamping portion having an expandable sleeve coupled to the mounting portion, attaching the mounting portion to a spindle of the machine, mounting one of a workpiece and a tool on the expandable sleeve, and tightening the clamping portion onto the mounting portion and the spindle to expand the expandable sleeve against the workpiece or tool.

### BRIEF DESCRIPTION OF THE FIGURES

FIG. 1 is a perspective view of an expanding arbor, of the present invention.

FIG. 2 is a side view of an expanding sleeve of the expanding arbor of FIG. 1.

FIG. 3 is an exploded perspective view of the expanding arbor of FIG. 1.

FIG. 4 is a side view of the finger of the expanding arbor of FIG. 1.

FIG. 5 is an exploded perspective view of a split ring fitted around the expanding sleeve on the mounting portion.

FIG. 6 is a side sectional view of the expanding arbor showing a nut securing the split ring to the mounting portion.

FIG. 7 is a partial cutaway view of the expanding arbor of FIG. 1 mounted in a collet housing in a spindle of a machine.

FIG. 8 is an exploded perspective view of an alternate embodiment of an expanding arbor.

FIG. 9 is a side sectional view of the mounting portion and the finger of the expanding arbor of FIG. 8.

### DETAILED DESCRIPTION

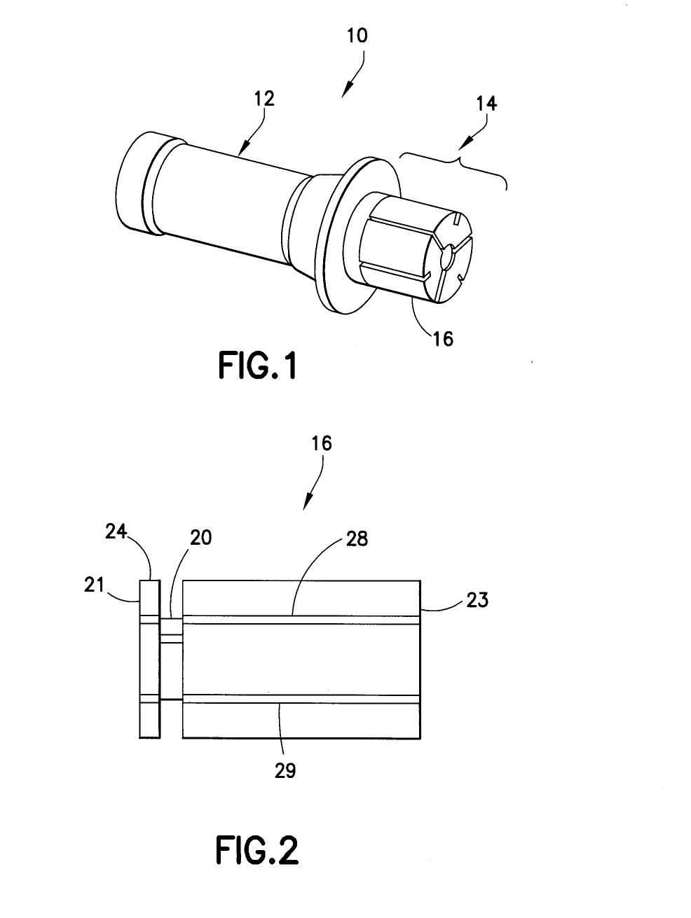

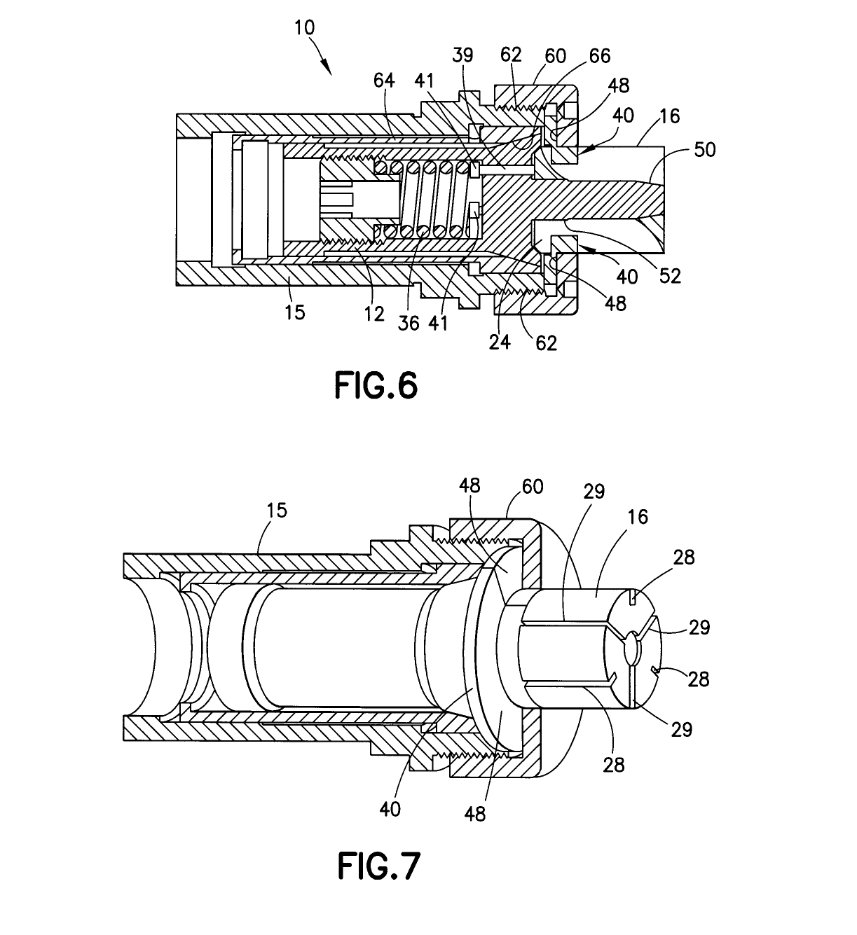

As shown in FIG. 1, an expanding arbor for rotatably clamping a workpiece or tool to a machine tool is designated generally by the reference number 10 and is hereinafter referred to as “arbor 10.” The arbor 10 comprises a mounting portion 12 and a clamping portion 14 extending from the mounting portion. In the illustrated embodiment, the clamping portion 14 is cylindrical and comprises an expandable sleeve 16 which, in use, is at least partially inserted into an aperture defined by the workpiece, and as explained in greater detail below, is caused to engage a wall that defines the aperture. The mounting portion 12 is coupled to a spindle (shown at 15 in FIGS. 6 and 7) forming part of the machine tool. During operation of the machine tool, the spindle, and thereby the arbor 10, is caused to rotate. The machine tool may be a lathe or any similar type of machine tool having a rotating spindle. Although the arbor 10 is hereinafter described as receiving a workpiece, it should be understood that the arbor may also be used to receive a tool. While a cylindrical clamping portion 14 has been shown and described, the present invention is not limited in this regard as other shapes such as square, hexagonal, and the like can also be employed without departing from the broader aspects of the present invention.

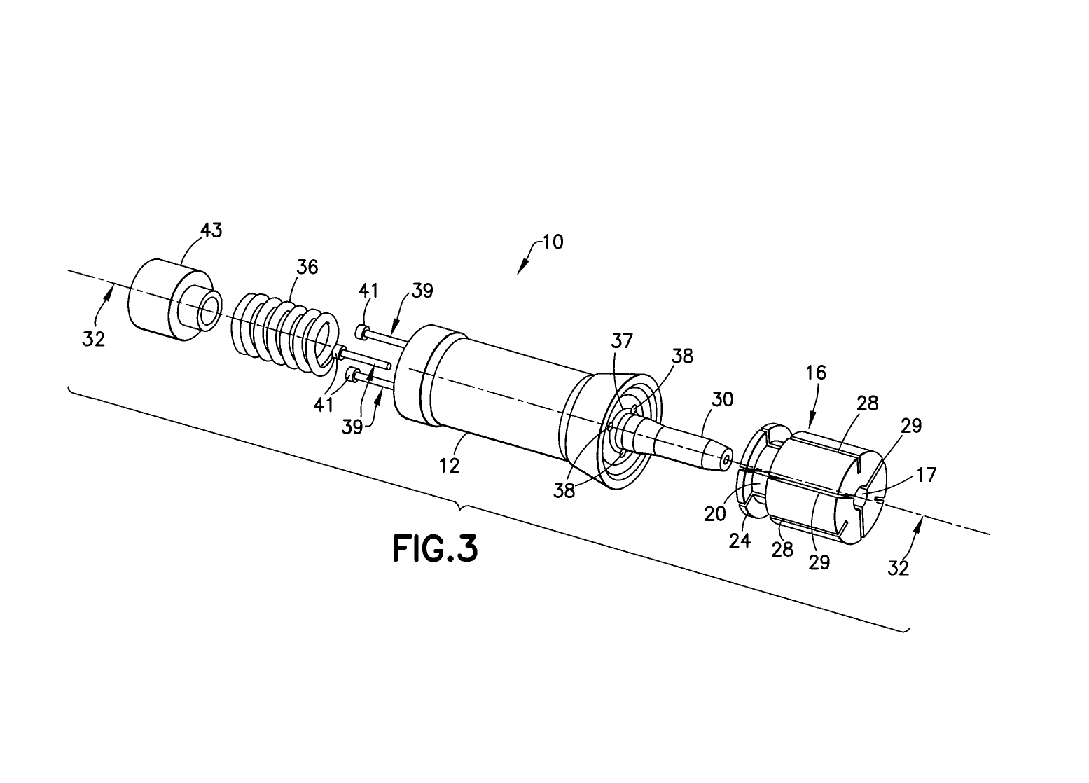

As shown in FIG. 2, the expandable sleeve 16 defines a groove 20 positioned proximate an end 21 thereof. A bore 17 (shown in FIG. 3) extends through the expandable sleeve 16. The expandable sleeve 16 defines a first plurality of slits 28 that extend longitudinally from the bore 17 at the end 21 through a flange 24 portion and along the expandable sleeve and terminate short of the bore at the second end 23. The expandable sleeve 16 also defines a second plurality of slits 29 that extend longitudinally from the bore 17 at the second end 23 and terminate short of the bore at the end 21. As will be explained in detail below, the slits 28, 29 facilitate the expansion of the sleeve to allow the sleeve to expand and engage a workpiece or tool and grippingly retain the workpiece or tool on the sleeve. Materials from which the expandable sleeve 16 can be formed include, but are not limited to, steel, hardened steel, titanium, and the like. The surfaces of the expandable sleeve 16 on which the workpiece is received may be coated, grooved, or smooth.

As shown in FIG. 3, the expandable sleeve 16 is received over a finger 30 forming part of the clamping portion 14. In the illustrated embodiment, the finger 30 is integrally formed with and extends outwardly from the mounting portion 12 of the arbor 10 and along an axis 32. Expandable sleeves of different outside diameters can also be received over the finger 30 to accommodate workpieces having various sizes of internal diameters. Holes 38 are located in a surface 37 of the mounting portion 12 equidistantly about the axis 32. Extracting pins 39 are positioned to slide in each hole 38, each extracting pin comprising a head 41 that, when the extracting pins translate through the holes 38, prevents the extracting pins from sliding completely through. A spring 36 is located inside the mounting portion 12 to urge the extracting pins 39 through the holes 38. The spring 36 is positioned in the mounting portion 12 and retained therein via a closing nut 43 threadedly engaged in the mounting portion. While the finger 30 has been shown and described as being integrally formed with the mounting portion 12, the present invention is not limited in this regard as the finger can also be threaded onto or otherwise coupled to the mounting portion.

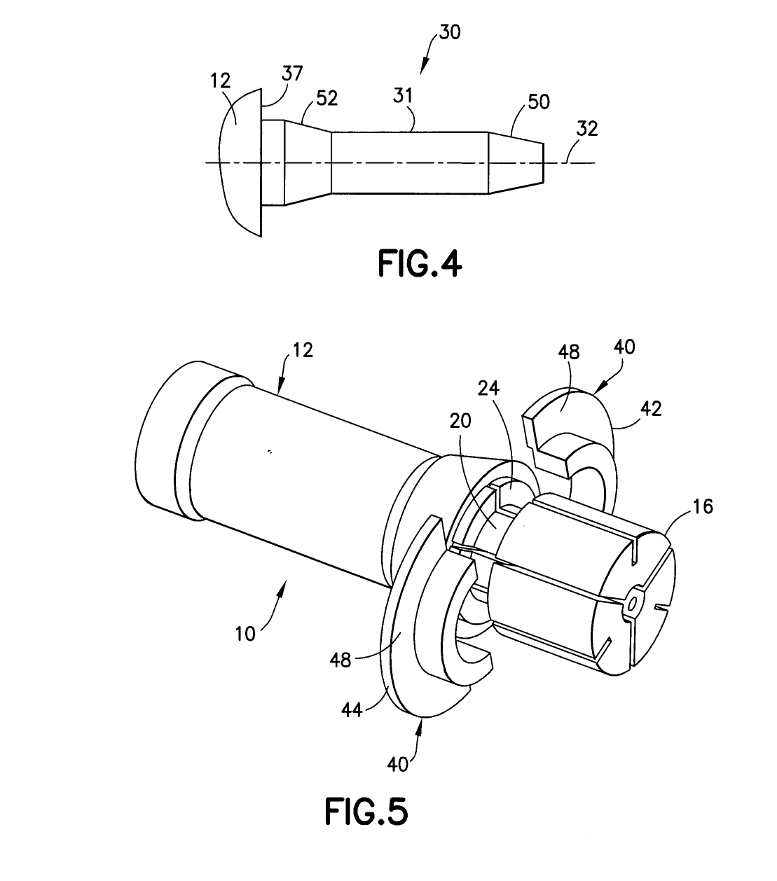

As shown in FIG. 4, the finger 30 is defined by a shaft portion 31 having a first tapered portion 50 on the end of the finger and a second tapered portion 52 at a base of the finger 30 proximate the mounting portion 12 of the arbor 10. The present invention is not limited in this regard, however, as only the first tapered portion 50 may be employed depending on the workpiece being mounted. Incorporation of the second tapered portion 52 at the base of the finger 30, however, allows the expandable sleeve 16 to expand in a more uniform manner, e.g., substantially the same amount at both ends.

As shown in FIG. 5, once the expandable sleeve 16 is received over the finger 30 and is pushed in the direction of the mounting portion 12, the flange 24 engages end portions of the extracting pins 39 extending out of the holes 38. A split ring 40 is fitted around the expandable sleeve 16. The split ring 40 comprises a first half 42 and a second half 44, each of which is fit around the expandable sleeve 16 in the groove 20. Each half of the split ring 40 is configured to define a surface 48.

As shown in FIGS. 6 and 7, a nut 60 is received over the expandable sleeve 16 and against the surfaces 48 of the split ring 40. The nut 60 is substantially cup-shaped and includes a hole therein to allow the cylindrical portion of the expandable sleeve 16 to be received therethrough. The flange 24, being larger in diameter than the hole through the nut 60, does not pass through the nut. The nut 60 also includes an internal thread 62 that is receivable on an external thread on the spindle 15 of the machine into which the mounting portion 12 is inserted.

To clamp a workpiece on the arbor 10, the expandable sleeve 16 is placed through the nut 60, the workpiece is placed on the expandable sleeve 16, and the nut 60 is tightened onto the spindle 15. Tightening the nut 60 onto the spindle 15 urges the split ring 40 against the extracting pins 39 protruding from the holes 38, thereby pushing the flange 24 against the mounting portion 12 of the arbor 10 and pushing the arbor into a collet housing 64 located in the spindle. Further tightening the nut 60 further draws the flange 24 against a tapered surface 66 in the collet housing 64. As the flange 24 is drawn against the tapered surface, the progressive engagement of the flange and the tapered surface 66 causes the expandable sleeve to move radially outward to engage and releasably retain a workpiece. In configurations in which the second tapered portion 52 is incorporated into the finger 30, the slits 28 allow for additional radial expansion of the expandable sleeve 16 proximate the end 21.

To unclamp the workpiece, the nut 60 is loosened on the spindle 15, and the spring 36 urges the extracting pins 39 in the direction of the clamping portion, which in turn urge the expandable sleeve 16 off the finger 30. In doing so, the expandable sleeve 16 (with the workpiece clamped thereto) can be removed from the finger 30. Upon removing the expandable sleeve 16 from the finger 30 and one or more of the first tapered portion 50 and the second tapered portion 52, the slits 28, 29 allow the expandable sleeve 16 to contract in size across the diameter thereof. As the expandable sleeve 16 contracts in size across the diameter, the workpiece is released.

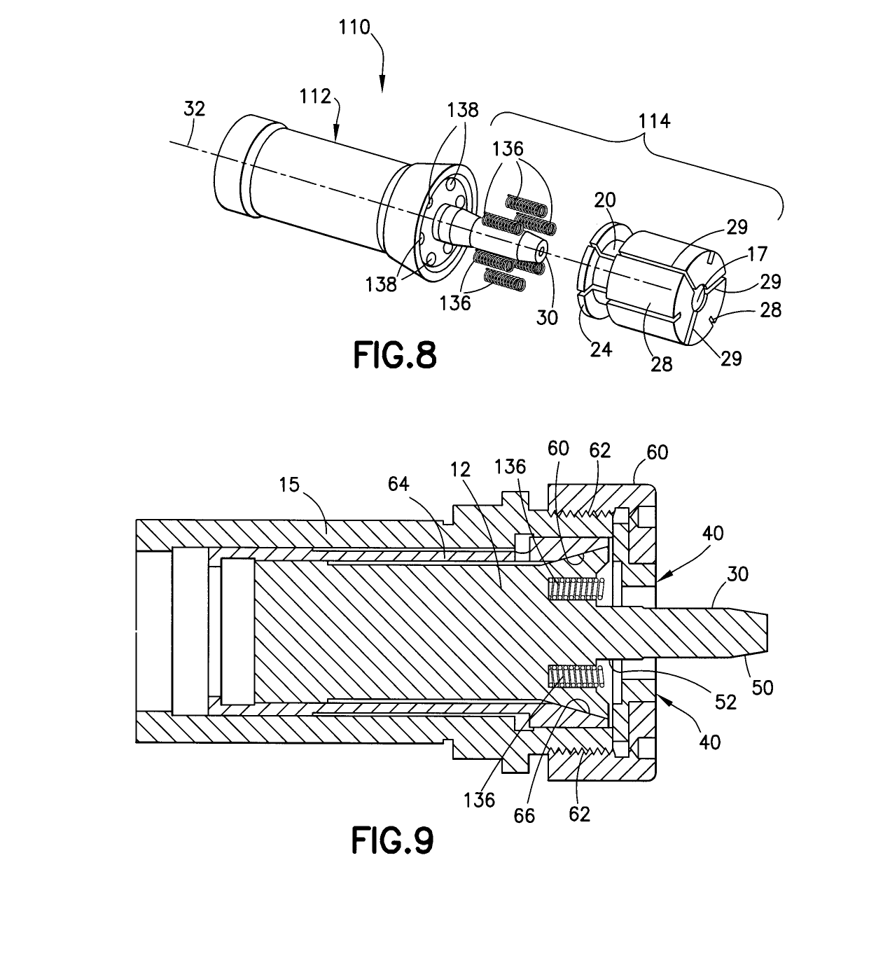

Referring now to FIG. 8, another embodiment of the expandable arbor is designated generally by the reference number 110 and is hereinafter referred to as “arbor 110.” The arbor 110 comprises a mounting portion 112 and a clamping portion 114 extending outwardly from the mounting portion, the clamping portion comprising an expandable sleeve 16 similar to that with regard to arbor 10 mountable over a finger 30. Holes 138 are located in a surface 137 of the mounting portion 112 equidistantly about an axis 32 extending longitudinally through the arbor 110. Springs 136 are located in each of the holes 138 such that a portion of each spring extends out of the hole. Upon receiving the expandable sleeve 16 over the finger 30, the portions of each spring 136 extending out of the holes 138 are engaged by the end 21 of the flange 24.

As shown in FIG. 9, a split ring 40 is placed around the expandable sleeve 16. A nut 60 is received over the expandable sleeve 16 and against surfaces 48 of the split ring 40. As with arbor 10, clamping a workpiece on the arbor 110 involves mounting the workpiece on the expandable sleeve 16 and tightening the nut 60 onto the spindle 15 to urge the split ring 40 in a forward direction. Upon continued urging of the split ring 40, the split ring engages the portions of the springs 136 protruding from the holes 138. Further tightening of the nut 60 compresses the springs 136, pushes the flange 24 against the mounting portion 112, and pushes the arbor 110 into the collet housing 64 located in the spindle 15. Still further tightening of the nut 60 further draws the flange 24 against a tapered surface 66 in the collet housing 64. As the flange 24 is drawn against the tapered surface, the progressive engagement of the flange and the tapered surface 66 causes the expandable sleeve 16 to move radially outwardly to engage and releasably retain a workpiece. In configurations in which the second tapered portion 52 is incorporated into the finger 30, the slits 28 allow for additional radial expansion of the expandable sleeve 16 proximate the end thereof.

To unclamp the workpiece, the nut 60 is loosened on the spindle 15, and the springs 136 urge the flange 24 and the expandable sleeve 16 off the finger 30. In doing so, the expandable sleeve 16 (with the workpiece clamped thereto) can be removed from the finger 30. Upon removing the expandable sleeve 16 from the finger 30 and one or more of the first tapered portion 50 and the second tapered portion 52, the slits 28, 29 allow the expandable sleeve 16 to contract in size across the diameter thereof. As the expandable sleeve 16 contracts in size across the diameter, the workpiece is released.

Although this invention has been shown and described with respect to the detailed embodiments thereof, it will be understood by those skilled in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

1.-17. (canceled)

18. An expandable arbor for mounting a tool or workpiece to a machine tool, the expandable arbor comprising:
a mounting portion configured to be rotatably coupled to a machine tool spindle; and
a clamping portion located on the mounting portion, the clamping portion comprising,
a finger extending from the mounting portion,
an expandable sleeve slidably positioned over the finger and movable relative thereto, the expandable sleeve comprising a flange located at an end thereof and a groove located adjacent to the flange, wherein the expandable sleeve is substantially cylindrical and includes a plurality of slits longitudinally arranged therein, the slits being effective to allow portions of the expandable sleeve to flex relative to one another to allow the expandable sleeve to expand as the expandable sleeve progressively engages the tapered portion;
a nut threadably engaged with the spindle for retaining the expandable sleeve thereon,
a split ring fitted around the expanding sleeve in the groove, the split ring being coupled to the mounting portion via the nut, and
the finger defining a tapered portion and wherein tightening the nut causes the expandable sleeve to progressively engage the tapered portion, thereby causing at least a portion of the expandable sleeve to move radially outwardly to engage and releasably retain a tool or workpiece.

19. The expandable arbor of claim 18, wherein the finger further comprises a second tapered portion at a base of the finger.

20. The expandable arbor of claim 18, further comprising a spring located in the mounting portion and a plurality of extracting pins in communication with the spring, the extracting pins being slidably located in the mounting portion to urge the expandable sleeve toward the nut.

21. The expandable arbor of claim 18, further comprising a plurality of springs located in a corresponding plurality of holes defined by the mounting portion, the plurality of springs being configured to urge the expandable sleeve toward the nut.

22. The expandable arbor of claim 18, wherein the expandable sleeve is fabricated from steel, hardened steel, or titanium.

23. A clamping system for a machine, the clamping system comprising:
an expandable arbor, comprising,
a mounting portion configured to be rotatably coupled to a machine tool spindle; and
a clamping portion coupled to the mounting portion, the clamping portion being configured to receive one of a tool and a workpiece thereon and comprising,
an expandable sleeve, the expandable sleeve being substantially cylindrical in shape, configured to be expandable in radial directions, and comprising a flange located at an end thereof and a groove located adjacent to the flange, wherein the expandable sleeve is substantially cylindrical and includes a plurality of slits longitudinally arranged therein, the slits being effective to allow portions of the expandable sleeve to flex relative to one another to allow the expandable sleeve to expand as the expandable sleeve progressively engages the tapered portion,
a nut threadably engaged with the spindle for retaining the expandable sleeve thereon, and
a split ring fitted around the expanding sleeve in the groove, the split ring being coupled to the mounting portion via the nut.

24. The clamping system of claim 23, wherein the clamping portion further comprises a tapered finger extending from the mounting portion, the tapered finger defining a tapered portion, and wherein tightening the nut causes the expandable sleeve to progressively engage the tapered portion, thereby causing at least a portion of the expandable sleeve to move radially outwardly to engage and releasably retain a tool or workpiece.

25. The clamping system of claim 24, wherein the expandable sleeve comprises a plurality of longitudinally oriented slits therein, the slits being configured to allow for the expansion of the expandable sleeve in the radial directions as the expandable sleeve progressively engages the tapered portion.

26. The clamping system of claim 23, further comprising a spring located in the mounting portion and a plurality of extracting pins in communication with the spring, the extracting pins being slidably located in the mounting portion to urge the expandable sleeve toward the nut.

27. The clamping system of claim 23, further comprising a plurality of springs located between the mounting portion and the clamping portion, the plurality of springs being configured to urge the expandable sleeve toward the nut.

28. A method of clamping one of a workpiece and a tool to a machine, the method comprising:
providing an expandable arbor defining a mounting portion and a clamping portion coupled thereto, the clamping portion comprising an expandable sleeve having a flange located at an end thereof and a groove located adjacent to the flange, and a split ring fitted around the expanding sleeve in the groove, wherein the expandable sleeve is substantially cylindrical and includes a plurality of slits longitudinally arranged therein, the slits being effective to allow portions of the expandable sleeve to flex relative to one another to allow the expandable sleeve to expand as the expandable sleeve progressively engages the tapered portion;
attaching the mounting portion to a spindle of the machine;
mounting one of a workpiece and a tool on the clamping portion; and
tightening the clamping portion onto the mounting portion and the spindle to expand the expandable sleeve against the workpiece or tool.

29. The method of claim 28, wherein tightening the clamping portion onto the mounting portion and the spindle comprises tightening a nut onto the spindle.
